(19) United States
(12) Patent Application Publication
(10) Pub. No.: US 2010/0040349 A1
(43) Pub. Date: Feb. 18, 2010

(54) SYSTEM AND METHOD FOR REAL-TIME SYNCHRONIZATION OF A VIDEO RESOURCE AND DIFFERENT AUDIO RESOURCES

(76) Inventor: Elliott Landy, Woodstock, NY (US)

Correspondence Address: LEIGHTON K. CHONG;PATENT ATTORNEY, 133 KAAI STREET, HONOLULU, HI, 96821, US

(21) Appl. No.: 12/582,102

(22) Filed: Oct. 20, 2009

Related U.S. Application Data
(63) Continuation-in-part of application No. 12/113,800, filed on May 1, 2008.

(51) Int. Cl. H04N 5/91; G06F 15/16

(52) U.S. Cl. 386/96; 709/231; 386/E05.001

(57) ABSTRACT

An audio-video system and method employs a dual-control interface for directly controlling the play speed of a video track while switching among a plurality of audio tracks independently of the video. The dual-control interface enables the user to adjust the play speed of the video track to match or synchronize with the tempo of a selected audio track at any point in time. The video speed and audio selection commands can be recorded as a file or on disk along with the underlying video and audio resources for playback or editing on PCs or game consoles. An Internet-enabled version can connect to streaming audio and/or video resources from Internet websites, for play on wireless mobile devices or Internet browsers. An Auto Beat feature may be used to automatically detect the beat of a currently selected audio track and convert it to the video track play speed. The audio-video system is particularly suitable for making personally editable music video and/or playing video games, audience participation (karaoke) games, and the like.

This U.S. patent application is a continuation-in-part of U.S. patent application Ser. No. 12/113,800 filed on May 1, 2008, by the same inventor, of the same title.

### TECHNICAL FIELD

This invention generally relates to a computerized system and method for creating and playing back multimedia programs, and particularly to tools for synchronizing the video and audio content in multimedia programs.

### BACKGROUND OF INVENTION

Multimedia programs that composite multiple sources of video and audio content in a final program typically require powerful audio/video formatting tools and editing systems to produce a finished program of video synchronized to audio. Raw video resources are converted to digital video format and desired video segments are digitally spliced on a video editing track. Similarly, raw audio resources are converted to digital audio and desired segments are digitally spliced on one or more audio editing tracks. The typical editing system enables the editor to adjust the playback speed of video segments on the video track relative to the speed and start/stop times of audio segments on the audio track in order to render the video and audio in synchronism with each other to produce a pleasing effect on the viewer/listener. However, due to the powerful tools used to produce seamless digital splicing of audio and video segments and fine adjustments for synchronization, the finished multimedia program can only be modified by re-editing on the editing system, and the underlying content for the video and audio segments cannot be accessed or changed directly.

Existing video editing and audio/video systems can typically be divided into linear and non-linear systems. Non-linear systems are capable of processing audio and video in any arbitrary order, whereas linear systems process audio and video in the order it was initially recorded and only in that order. Linear systems can further be divided into real time and non real time systems. Real time linear systems are capable of processing such audio and video at the same speed in which it was recorded, whereas linear systems which are unable to process audio and video at that speed are termed non real-time systems.

Examples of audio-video editing systems in the prior art are shown, for example, in U.S. Pat. No. 5,237,648 to Mills et al. which discloses an editing system with a control interface having a slider bar for controlling playback speed in combination with radio buttons to control the playback of video and audio tracks. US Published Patent Application 2002/0161794 and U.S. Pat. No. 7,076,495 to Dutta et al. show a media playback device with playback controls to manipulate the playing back of stored captured screen images at a rate chosen by the user, such as for playing at a slower rate for users having cognitive disabilities. A sliding bar control can be set by the user to set the speed at which successive screen images are displayed. US Published Patent Application 2003/0122862 to Takaku et al. shows a multimedia editing and playback system for editing and playing back intermediate and final results of the editing process. An edit instruction unit has a control interface for inputting user's edit selections and issuing edit operating instructions. US Published Patent Application 2003/0146915 to Brook et al. shows a multimedia editing system with a graphical user interface (GUI) that includes a video/still image viewer window and a synchronized audio player device. The GUI system has a simplified time-line, containing one video--plus--sync audio track, and one background audio track, where the two audio tracks can be switched to be visible to the user. Audio clips can be selected in a sequence, or can be dragged and dropped onto a playlist summary bar for use in creating a sequence of audio segments.

Examples of synchronization methods in prior systems are shown, for example, US Published Patent Application 2004/0027369 to Kellock et al. which discloses an editing system for automatically editing motion video, still images, music, speech, sound effects, animated graphics and text. The timing of events within the video can be synchronized with the beat of the music or with the timing of significant features of the music. US Published Patent Application 2004/0267952 to He et al. discloses a multimedia editing system with variable play speed controls for media streams including a built-in streaming media platform enabling third party developers to access and take advantage of the variable play speed control, and the ability to implement variable play speed control on media streams from a variety of sources including streaming media servers. U.S. Pat. No. 6,414,686 to Protheroe et al. discloses a multimedia editing system the editor uses interface controls to play a selected video clip using sliders to control the playing rate of the video. US Published Patent Application 2005/0275758 to McEvilly et al. discloses a playback control unit for controlling the playback of video content on a network by checking the contents schedule to ensure that the requested playback control is not prohibited and, if it is not, uses tag data associated with the content being streamed to control the data that is streamed to the user.

US Published Patent Application 2006/0129933 to Land et al. shows a system for creation and presentation of multimedia content, such as greetings, slideshows, websites, movies and other audio-visual content. The playback controls allow for speed of change, degree of change, various other options, etc. The default settings for these parameters may be randomized to provide a variety of behaviors. US Published Patent Application 2006/0271977 to Lerman et al. discloses video editing through a server application in which a self-contained editing software is embedded in the user's browser. The playback controls include a fast-forward feature, a rewind feature, a pause feature, stop feature, a record feature, an on/off feature, a rate feature, a transmission feature, and other playback control features. US Published Patent Application 2006/0009983 to Magliaro et al. discloses a system for controlling the playback rate of real-time audio data received over a network

Also, U.S. Pat. No. 6,762,797 to Pelletier discloses a playback interface configured to control playback speed of video and audio streams provided to a viewing device from a storage mechanism in accordance with accelerated playback speed. US Published Patent Application 2007/0260690 to Coleman discloses an editing system with synchronization controls for different types of media that may be on different tracks or played from an external source. For External Synchronization of multiple threads, the starting time for all media types is strictly synchronized and each thread plays independently based on the associated media types. Users may use the play controller to change the position or rate of video playing.

Examples of still-image video usage in prior systems include, for example, US Published Patent Application 2005/0066279 to LeBarton et al. shows a system for capturing still images and playing back in sequential series. The user can record audio and/or insert sound effects and music accompaniment to play along with the still-image animation. US Published Patent Application 2005/0231513 to LeBarton et al. shows a stop-motion video editing system in which the frame rate of the movie can be changed at any arbitrary point by changing the frame hold time. Audio is added and synchronized to the animation by inserting an audio cue at a desired frame within the animation to start playing at that frame. U.S. Pat. No. 6,735,253 to Chang et al. shows a system for editing video over a network that has a tool for variable speed playback, and another tool for strobe (still-image) motion that is a combination of freeze frame and variable speed playback.

Existing audio/video editing systems are explicitly designed to maintain fixed synchronization between the underlying audio and video tracks, so that the end result is a program in which video and audio streams are synchronized together and play together “in lockstep”. In a typical implementation, timecode values are stored in both the audio and video streams. These timecode values are used by the playback engine to maintain synchronization between the video and audio tracks during playback. These timecode values may either reflect a common time base, such that the timecodes within the audio tracks are directly comparable to the timecodes within the video tracks, or the audio timecodes may be offset from the video timecodes by a fixed value. In either case, a single incrementing time counter can be used to maintain synchronization between the audio and video during playback. Thus, the audio and video are kept in synchronization both with respect to each other and to a single master time counter.

However, the prior types of audio-video editing systems do not enable a user to edit or playback an audio-visual program directly from the underlying video and audio resources while synchronizing the video and the audio independently of each other in real-time in a simple manner using easy-to-operate interface controls. The end result of a typical audio/video editing system is a final product that is disconnected from the underlying resources. The existing editing systems save the results of the editing process as a work-in-progress in which the selected video and audio segments are excerpted from the underlying video and audio resources. They do not allow the user in re-editing or playback modes to adjust the video speed of the underlying video resource while simultaneously switching among multiple underlying audio resources in order to aesthetically match the video to the audio in real-time.

### SUMMARY OF INVENTION

In accordance with the present invention, an audio-video system operable on a computer device comprises:

(a) a video controller for running an underlying video resource composed as a series of digital image frames of visual content for video output;

(b) an audio controller for running a plurality of underlying audio resources and selectively switching among them for audio output, wherein any one of the underlying audio resources can be selectively switched by the audio controller for audio output; and

(c) a dual-control interface operable by a user of the system for controlling the underlying video resource and plurality of audio resources, wherein said dual-control interface includes a video speed control for providing a video speed command to the video controller for adjusting the running speed of digital image frames of visual content from the video resource at any point in time, and an audio selection control for providing an audio selection command to the audio controller for selectively switching to any one of the plurality of underlying audio resources for audio output at any point in time independently of the video speed control.

The video speed control adjusts the running speeds of the video at different points in time of the underlying video resource. Independently, the audio selection control switches to any of the underlying audio resources at different points in time for the audio output. The user can adjust the running speed of the underlying video resource independently of the running speed of the underlying audio resources which are selected to play at different points in time, thus allowing the user to independently synchronize the audio and video resources and enabling the audio and video resources to play back at different rates from each other. The dual-control interface for the system can be played extemporaneously for composing in real-time. It can also be used to edit an AUDIO/VIDEO program so that the video speed and audio selection commands can be recorded as an output file for playback. The recorded script of video speed and audio selection commands can be played back to control the underlying video and audio resources in real-time. Modifications to the audio-video program can be made simply by modifying in real time the commands that call the various underlying video and audio resources into use.

The audio-video system of the invention can use a raw video resource or one that has been edited from one or more raw video resources and converted to digital format for use in the system. Similarly, the user can use pre-recorded audio resources or even live audio input as an audio resource which may or may not be recorded by the user and saved into the application file. The user operates the dual-control interface to select the audio resource to be played at any point in time while adjusting the speed of the video to aesthetically match it. For example, the video speed can be adjusted to run slower if a song with a slow beat is selected for playing, and adjusted to run faster if a song with a fast beat is selected for playing. The user can thus independently synchronize the video track such that it aesthetically matches any selected audio track in real-time using the dual-control interface.

The audio tracks may be short segments that are run by clicking on a selection button on the control interface. Alternatively, they may be long-format audio or looped track, and can be cued to all start together at the same time and switched to run at different points in time of the program. A cuing control is used for cuing the plurality of audio resources to run together so that the user can quickly hop from one running audio track to another to play different songs, cadences, or audio themes that go together with different topics or themes shown in the video track.

The audio and video can thus be independently synchronized simply by operating the video speed control and the audio selection control linked to the underlying video and audio resources. The direct control of underlying resources enables composing, editing, re-editing and playback to be performed on the same system using the same control interface. This avoids the need to have modifications to the program done through a full-function editing system, and enables the system to be used extemporaneously for personal entertainment and music video games in which the user can compose their own programs and modify them in real-time at will.

In a particularly preferred embodiment, the video is in the form of a series of still-image frames from stop-motion photography. Playback of the still-image frames creates the effect of a strobe or animation video. Adjusting the running speed of the still-image frames faster or slower is absorbed by human perception as an increase or decrease in tempo while hopping among different audio tracks. In contrast, changing the speed of full-motion video would be perceived as speeded-up or slow-motion video. Constantly shifting between speeded-up or slow-motion video can become tiring or objectionable to human perception. Changing the running speed of still-image photo frames is perceived as less objectionable to human perception, and therefore is preferred for use with the video speed control in the invention system.

The video speed and audio selection commands can be recorded and distributed on disk along with the audio-video application and underlying video and audio tracks. It can thus be operated for play on PCs or game consoles, or used as media for play on wireless mobile devices or Internet browsers. The audio-visual system is particularly suitable for making personally editable music video and/or playing video games, audience participation (karaoke) games, and the like.

The present invention thus provides the real-time ability to adjust the speed of a video resource independently of the audio resource selected, while simultaneously allowing the user to switch among any of a multiple of audio tracks. The audio and video resources are deliberately not locked in synchronization with each other, but in fact each can be adjusted/selected independently. This is in contrast to conventional audio-video editing systems which are designed to maintain synchronization between audio and video tracks, so that the end result is a program in which video and audio streams are synchronized together and play together “in lockstep.”

A further, Internet-enabled embodiment manages audio and/or video resources in the form of streaming media obtained from one or more websites on the Internet, and stores the website link(s) with the recorded script for linking to the audio or video resources during later playback or modification. The Internet-enabled embodiment can be adapted to mobile Internet-connected handheld devices such as an Apple iPhone™ or iPod™ with functions for queuing multiple song choices, buffering and controlling the speed of a streaming video resource, and converting the device inputs (touch gesture inputs) into parametric values for storing with a recorded script.

Other objects, features, and advantages of the present invention will be explained in the detailed description below with reference to the following drawings.

### BRIEF DESCRIPTION OF DRAWINGS

FIG. 1 is a schematic diagram of a system and method for synchronizing a video track to aesthetically match different audio tracks, in accordance with the present invention.

FIG. 2A illustrates an example of the process steps for use of the invention system.

FIG. 2B illustrates a state diagram of control instructions selected by the user in an example of adjusting the video speed to aesthetically match different audio tracks.

FIG. 3 illustrates the same example in a time sequence diagram.

FIG. 4 shows an example of the editor/player display, audio track selection box, and speed adjustment box looks in an example of the control interface.

FIGS. 5-9 are schematic diagrams illustrating tools and options in an example of the control interface for the editor/player.

FIG. 10 shows a dialog box for setting general preferences for the audio-video program.

FIG. 11 shows a dialog box for setting default directories for the audio-video program.

FIG. 12 illustrates a state diagram of functions for an Internet-enabled embodiment for adjusting the video speed to synchronize with different audio tracks.

FIGS. 13A-13E illustrate user interface displays for functions of the system adapted to a mobile Internet-connected handheld device such as an Apple iPhone™ or iPod™ device.

### DETAILED DESCRIPTION OF INVENTION

In the following detailed description, certain preferred embodiments are described as illustrations of the invention in a specific application or computer environment in order to provide a thorough understanding of the present invention. Those methods, procedures, components, or functions which are commonly known to persons of ordinary skill in the field of the invention are not described in detail as not to unnecessarily obscure a concise description of the present invention. Certain specific embodiments or examples are given for purposes of illustration only, and it will be recognized by one skilled in the art that the present invention may be practiced in other analogous applications or environments and/or with other analogous or equivalent variations of the illustrative embodiments.

Some portions of the detailed description which follows are presented in terms of procedures, steps, logic blocks, processing, and other symbolic representations of operations on data bits within a computer memory. These descriptions and representations are the means used by those skilled in the data processing arts to most effectively convey the substance of their work to others skilled in the art. A procedure, computer-executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “icomputing” or “translating” or “calculating” or “determining” or “displaying” or “recognizing” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

A computer or computing resource commonly includes one or more input devices electronically coupled to a processor for executing one or more computer programs for producing an intended computing output. The computer is typically connected as a computing resource and/or communications device on a network with other computer systems. The networked computer systems may be of different types, such as remote PCs, master servers, network servers, and mobile client devices connected via a wired, wireless, or mobile communications network.

The term “Internet” refers to a structure of global networks connecting a universe of users via a common or industry-standard (TCP/IP) protocol. Users having a connection to the Internet commonly use browsers on their computers or client devices to connect to websites maintained on web servers that provide informational content or business processes to users. The Internet can also be connected to other networks using different data handling protocols through a gateway or system interface, such as wireless gateways using the industry-standard Wireless Application Protocol (WAP) to connect Internet websites to wireless data networks. Wireless data networks are now deployed worldwide and allow users anywhere to connect to the Internet via wireless data devices.

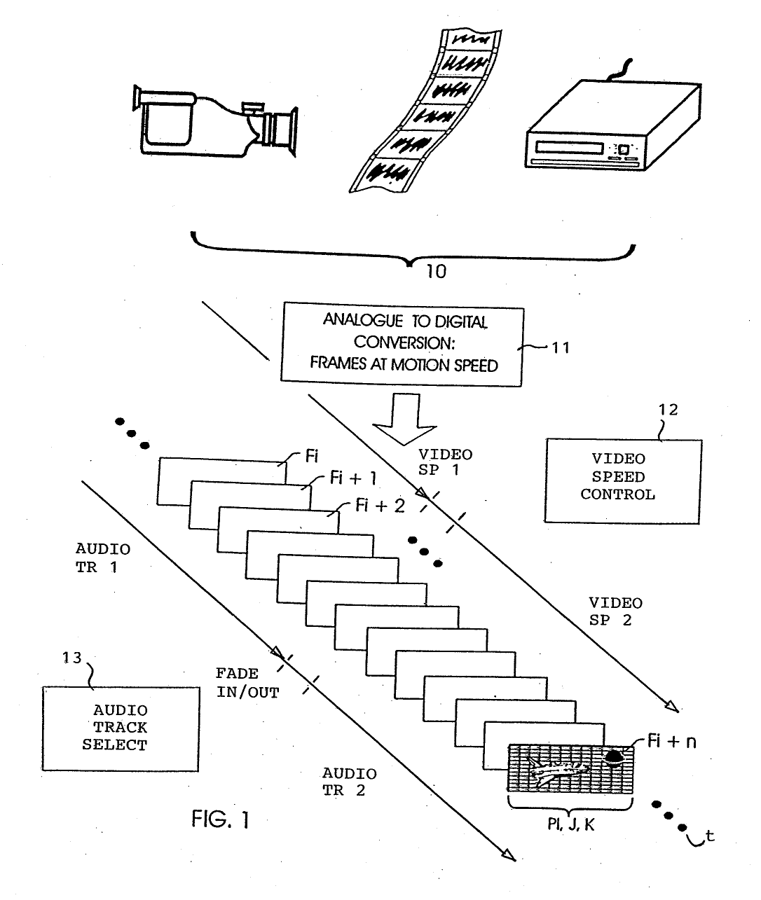

FIG. 1 shows a schematic diagram of the basic process steps for the audio-video system and method of the present invention. Video content from video sources 10, such as raw or edited footage from a videocam, or a series of still-image photographs, or video from a CD or DVD player, is captured and/or converted to a digital video file in a capture/conversion step 11. The digital video file consists of a series of image frames Fi, Fi+2, Fi+3, . . . , Fi+n, in a time sequence t. Each image frame F has a frame address i, i+1, i+2, . . . , i+n corresponding to its unique position in the sequence. Particular image frames may be identified as representing turning points in the multimedia program, such as an incident (PI), scene change (J), or thematic change for music (K). These turning points can be used by a user as editor to address the points at which different audio tracks are to be introduced.

The system includes at least two types of controls in a dual-control interface. A video speed control 12 enables the user to adjust the speed (frame rate) of the video track to different speeds. In the diagram, a video track is shown running at a first speed (SP 1), then is adjusted by the video speed control 12 to run at another speed (SP 2). A short transition period, which may be near instantaneous so as to be imperceptible, or may be a longer fade in/out type of transition, is indicated (in dashed cross-hatch lines) for the adjustment from Video Speed 1 to Video Speed 2. As a further option, the system may be configured to use dual video tracks, each with its own speed control and the capability to superimpose them on one another.

An audio selection control 13 enables the user to select among different audio tracks to run at different points in time of the running of the video track. In the diagram, a first audio track (TR 1) is selected by the selection control 13 to run with the video track at frame Speed 1, then a second audio track (TR 2) is selected to run with the video track at the frame Speed 2. A short transition period is also indicated (by dashed cross-hatch lines) for the switch from Audio Track 1 to Audio Track 2. In this manner, different audio tracks can be selected for play by the selection control 13 for different incidents, scenes, or themes depicted in the video track, and simultaneously the video speed can be adjusted by the video speed control 12 to run faster or slower to match the tempo or length of the audio track. With simply these two controls, the system can change audio segments and adjust their synchronization to the video directly from the underlying audio and video tracks. In effect, switching among audio tracks is like playing a medley of songs or tunes at will, and adjusting the speed of the video frames is like playing an instrument for visuals.

For raw footage that is full motion video, a sequence of 30 image frames is typically generated per second of video. However, the video file may be created as a series of still-image frames from stop-motion photography. Playback of such still-image frames creates the effect of a strobe or animation video which, when adjusted to run at faster or slower frame speeds, can be absorbed by human perception as an increase or decrease in tempo. In contrast, changing the speed of full-motion video would be perceived as shifting between speeded-up and slowed-down video, which can become tiring or objectionable to human perception. Changing the running speed of still-image photo frames is perceived as less objectionable to human perception, and therefore is preferred for use with the video speed control in the invention system. A “skip frame” feature (skipping every i-th frame) may be provided to make normally-shot videos seem more strobe-like and have a better visual effect in this system.

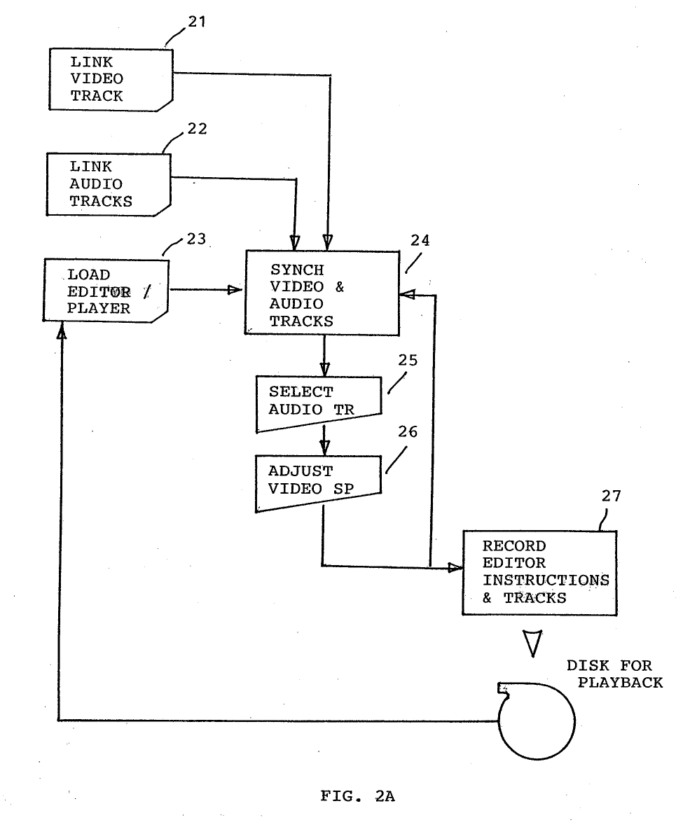

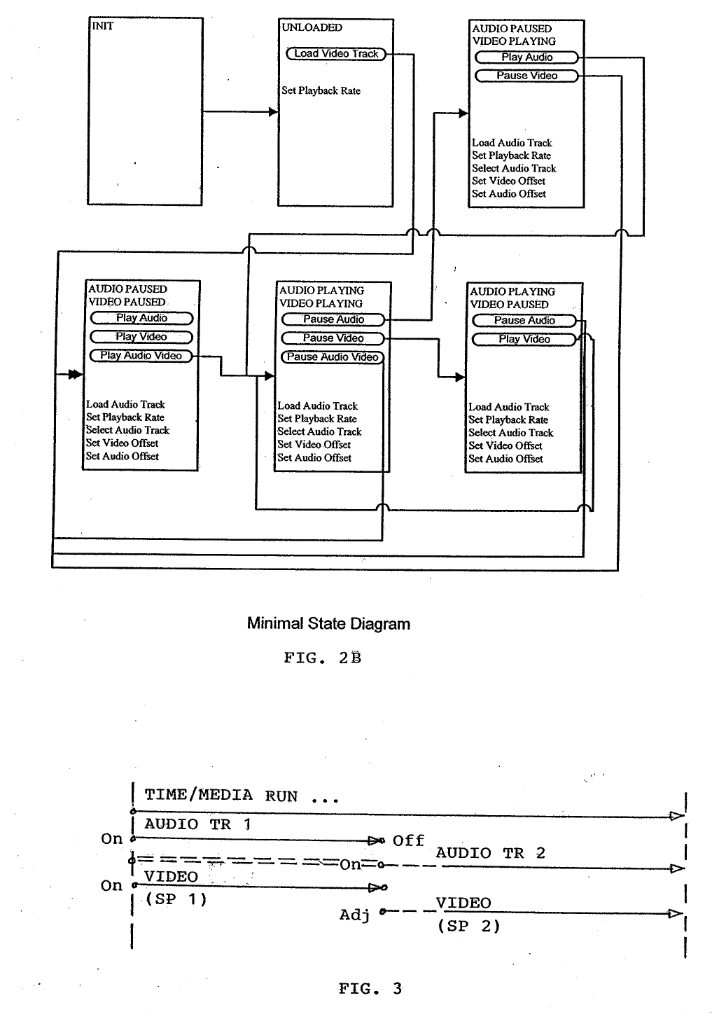

FIG. 2A illustrates the functional sequence for use of the invention system. In Step 21, the user links an video resource (file) to the system that has been captured or composed from one or more video resources for use in the program. In Step 22, the user links several audio resources (songs, recordings, microphone input) for use in the program. Live audio input may be used as one of the audio resources, and may be recorded by the user and saved as an audio resource file. In Step 23, the user loads editor/player system software on the computer, player, or other client device for running the audio-video program. As the editor/player software primarily operates simple video speed and audio track selection controls that work directly with underlying audio and video resources, the software footprint can be made very small for use on thin client devices and game consoles. In Step 24, the user operates the editor/player dual-control interface to select an audio track (at Step 25) from the several tracks linked to the program and to adjust the speed of the video track (at Step 26) to synchronize its frame rate with the tempo or length of the currently selected audio track. The control instructions used to control the audio and video tracks are recorded (at Step 27) as the session progresses, and the control sequence loops for each further audio track selection and/or video speed adjustment until the end of the program is reached. When the program is completed, the control commands and underlying audio and video resources can be recorded on a CD or DVD disk for re-editing or playback on a computer, mobile device, internet, etc. For playback, the process returns to the beginning for linking the video track and selected audio tracks with the editor/player software.

During playback, the audio track group and the video track play independently of one another. The audio plays at the constant rate at which it was recorded. The video plays at a rate which corresponds to the playback speed selected by the user. The relationship of when the audio starts to play, in reference to the beginning of the timeline, is set when the user loads the audio file. At the time the audio track is loaded, the user selects the position in the timeline at which the audio track will start to play. Prior to that point in the timeline, that particular audio track will be silent.

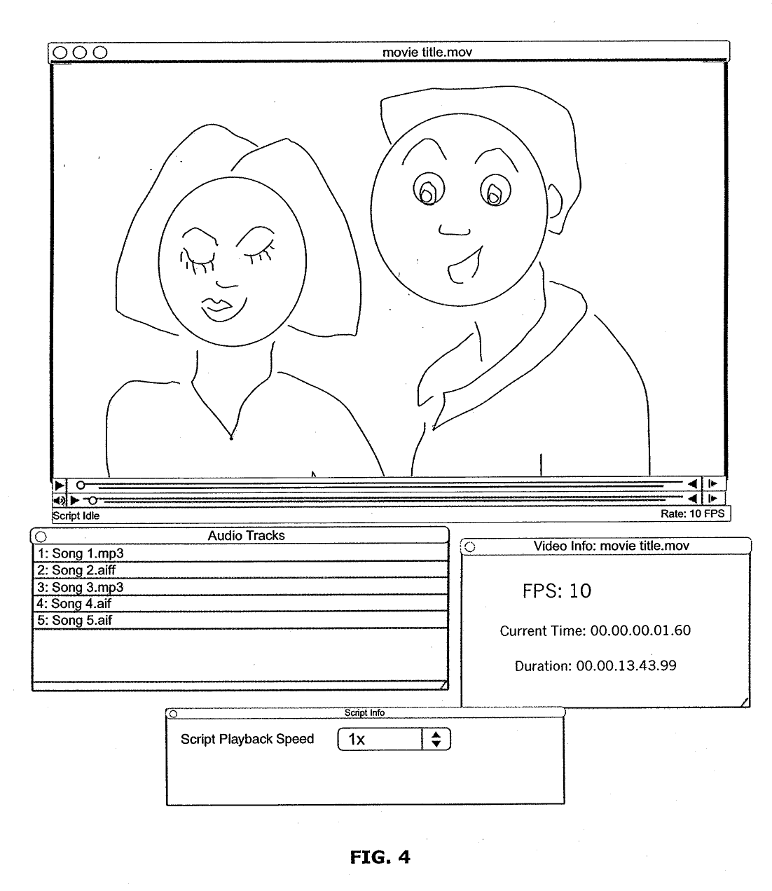

FIG. 2B illustrates a state diagram of control instructions input by the user, for example, for selecting an Audio Track 1 and adjusting the video speed to aesthetically match it, then selecting an Audio Track 2 and adjusting the video speed to aesthetically match it (to be described in further detail below). FIG. 3 illustrates this same process in a time sequence diagram. FIG. 4 shows an example of how the editor/player display may look with the current audio track selection highlighted in an audio track selection box and the current video speed displayed along with a speed adjustment box (script playback speed).

### Software Implementation of Preferred Embodiment

In an example of a preferred embodiment, RealBasic objects and the Apple QuickTime API are used to implement many of the features of the invention, including the parsing of audio and video files and playback of audio and video streams. Two QuickTime movies are used. The first is the video movie, which is used to contain and control the video track. The second is the audio movie, which is used to contain and control the audio tracks. The audio “movie” switches between audio tracks by selectively enabling one of the tracks and disabling the rest. Even though only one track can be heard at a time, they are essentially all playing simultaneously and QuickTime handles the details of synchronizing them to each other. Each audio track may contain one or more audio streams, for example a stereo sound track.

Two independent playback timers and two independent rate calculations are used to maintain independent synchronization of the audio and video tracks, enabling the audio and video tracks to play at different rates. Video playback is synchronized using the video playback timer and the video rate calculation. Each frame of video is maintained on screen for a duration that is determined by the current video playback rate. Audio playback synchronization is handled by QuickTime, using an audio timer and a rate calculation which are independent of their video counterparts. During playback, each of the loaded audio tracks is synchronized to each other and the audio playback timer. Even though only one audio track can be heard at a time, they are essentially all playing simultaneously. The application software begins executing once it is partially or completely loaded from the storage device into local memory.

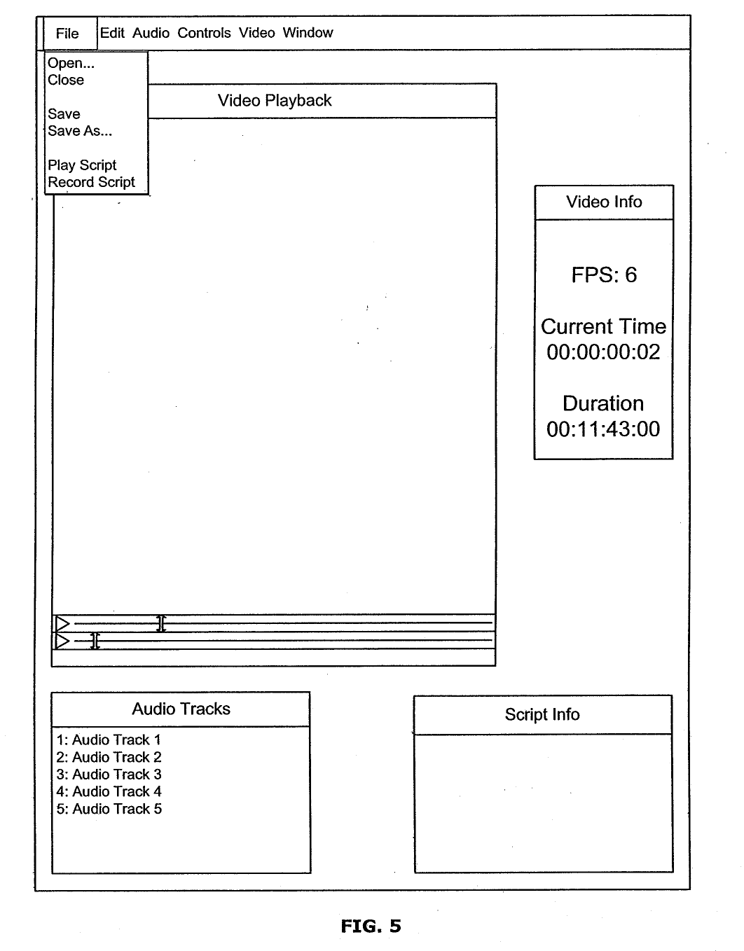

A control interface for the editor/player is presented to the user on the display for the PC, player or other client device, as illustrated for example in FIGS. 5-9. The initial display consists of a menu, audio track selection window, video info window, and script info window. Dialog boxes are also displayed to the user at various times in response to user actions. For use of the player/editor in the PC environment, the user may interact with the system using a keyboard and/or mouse. Menus are used to present various options to the user and they may be invoked either by pointing to and clicking on them with the mouse or by using various keyboard keys.

In FIG. 5, from the “File” menu, the user may choose “Open . . . ”, to open a video file or “Close”, to close an already opened video file. If the user clicks on the “File” menu and selects the “Open . . . ” option, a standard file selection dialog box is then presented to the user within which the user is able to select a movie file to be opened. Once the movie file is selected, the user clicks on the open button, at which point the dialog box is closed and a new video playback window is opened. The first image contained in the video file is displayed in this new video window, therefore giving the user an initial visual representation of the video file. If there are any audio tracks contained in the movie file then the names of each of the audio tracks is added to the audio tracks selection window. There may be multiple video tracks (channels) as well.

In FIG. 5, from the “File” menu, the user may select various file management functions, such as “Open”, “Close”, “Save”, “Save As”, “Play Script” and “Record Script”.

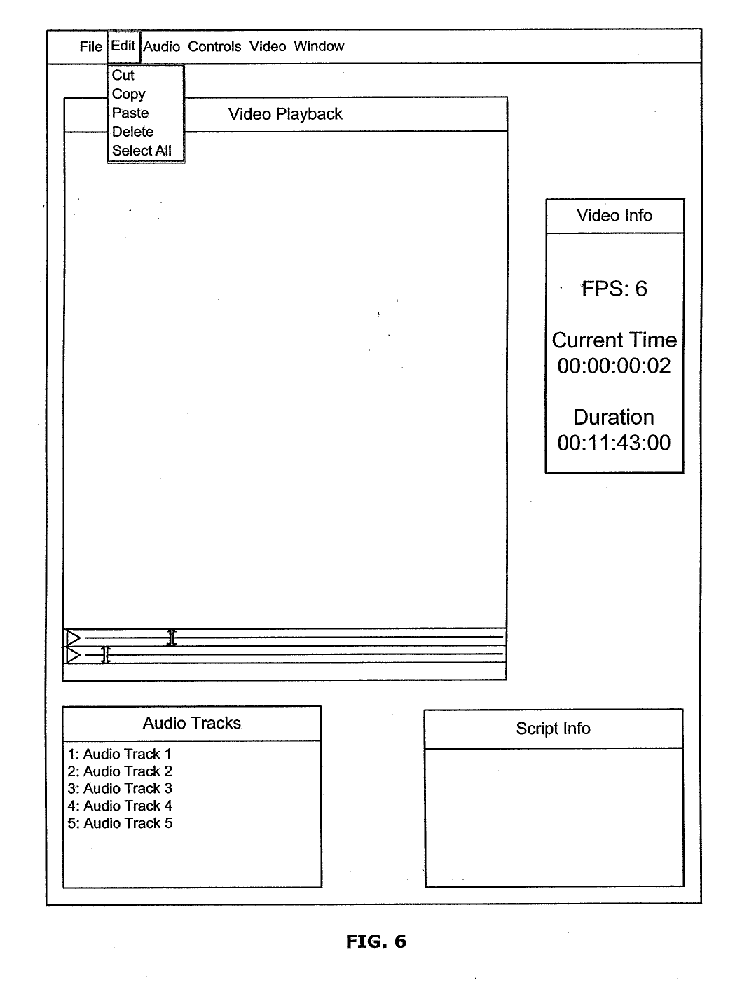

In FIG. 6, from the “Edit” menu, the user may select from among various AUDIO/VIDEO file editing functions

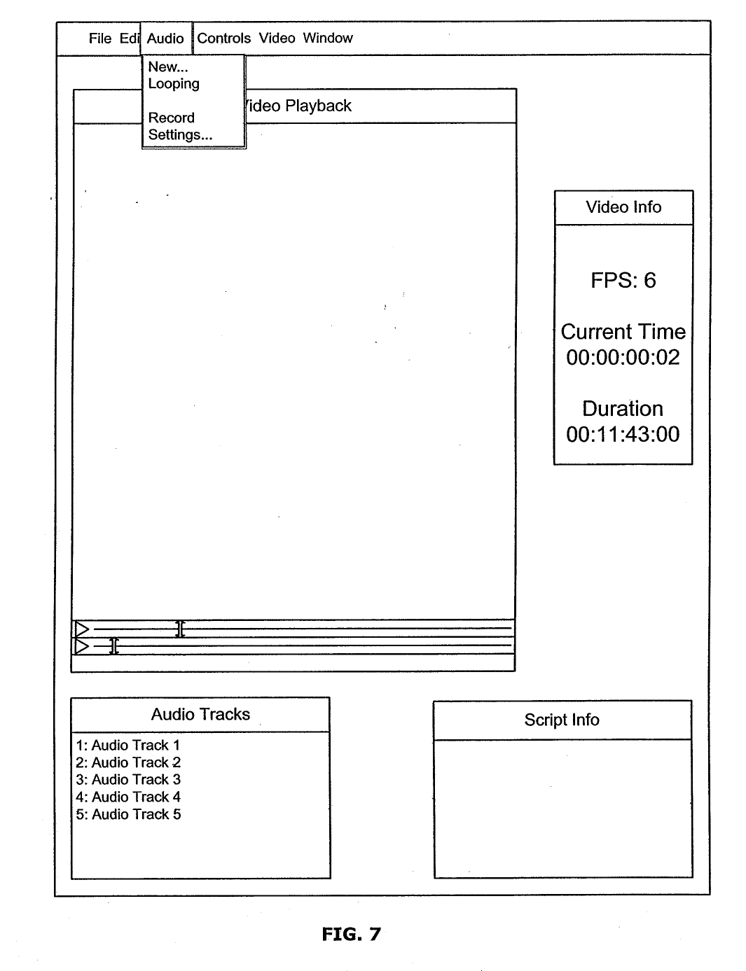

In FIG. 7, from the “Audio” menu, the user may select the “New . . . ” option, to open an additional audio file. The “New . . . ” option is only selectable after a video file has been loaded. If the user clicks on the “Audio” menu and selects the “New . . . ” option, a dialog box is presented to the user allowing them to choose between two options: “Insert at the beginning” or “Insert at the current position.” If “Insert at the beginning” is chosen, the initial offset of the newly opened audio track is set to zero. If “Insert at the current position” is chosen, the initial offset of the newly opened audio track is set to the current audio time index. Once the user chooses one of the two options, this initial dialog box is closed and a standard file selection dialog box is then presented to the user within which the user is able to select an audio file to be opened. Once the audio file is selected, the user clicks on the open button, at which point the file selection dialog box is closed and the names of each of the audio tracks contained in the selected audio file is added to the audio track selection window. Additional audio tracks can be loaded by repeating this procedure for each audio track. Audio may also be dragged and positioned either at the beginning of a movie or at a user determined point in the movie time line.

After a video track and one or more audio tracks are loaded, the user can choose to play the video and audio by pressing the “space bar” key, at which point the video movie and the audio movie will begin playing. Each frame of video from the video movie is sequentially displayed within the video window. The rate at which the frames are displayed is controlled by the current setting of the video playback rate. Pressing the “space bar” key toggles between the playback state, where the video track and audio track are being played back, and the paused state, where video track and audio track are both paused. Alternatively, the user may choose to play only the video track by selecting the “Play/Pause” icon on the video playback timeline. The video track may be toggled between the play and paused states by selecting the “Play/Pause” icon. Similarly, the user may choose to play only the audio track by selecting the “Play/Pause” icon on the audio playback timeline. The audio track may be toggled between the play and paused states by selecting the “Play/Pause” icon.

The current playback position of the audio track can be changed independently of the current playback position of the video track by dragging icons and positioning them in relationship to one another. Alternatively, the current playback position of the audio track can be changed simultaneously with the current playback position of the video track by dragging both icons together.

In the preferred embodiment, only one audio track is audible at any given time. All other audio tracks are silent. The currently selected audible audio track will play back at the playback rate that is indicated by the selected audio track's file metadata, which is typically the rate at which the audio track was recorded. Thus, playback of the selected audio track will occur at normal speed. However, playback of the video track will proceed at the currently selected video playback rate, which is user configurable.

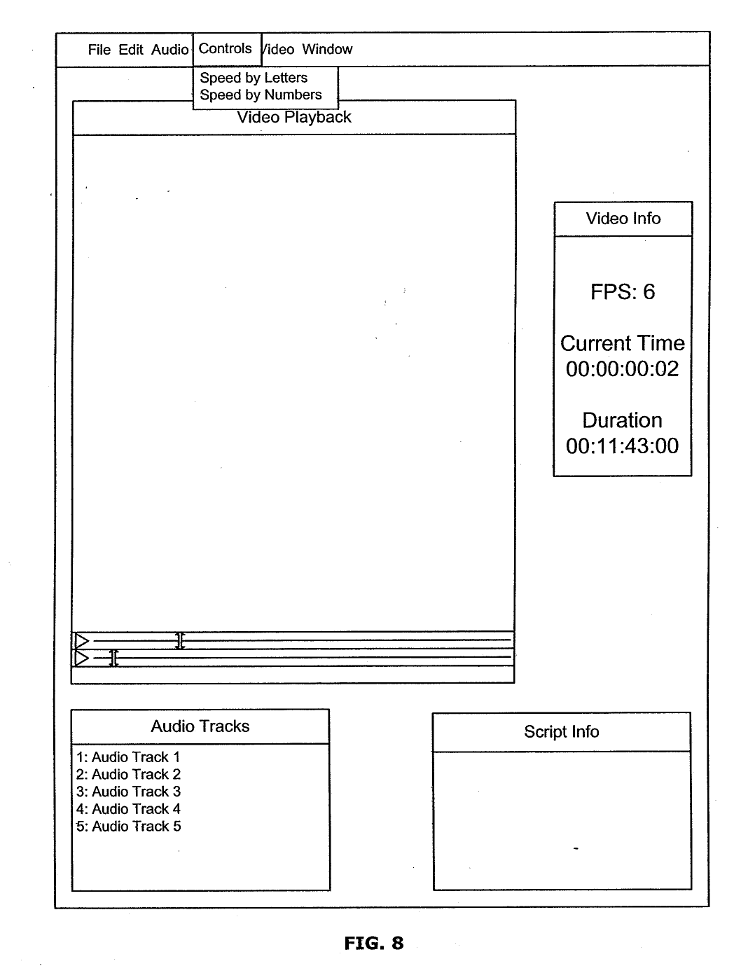

In FIG. 8, from the “Controls” menu, the user may select to input instructions for video speed adjustment by “Letters” or “Numbers”. For example, the user can adjust the video playback rate using letter keyboard commands such as:

“z”—Set video playback rate to 1 frame per second.

“x”—Set video playback rate to 2 frames per second.

“c”—Set video playback rate to 3 frames per second.

“v”—Set video playback rate to 4 frames per second.

“b”—Set video playback rate to 5 frames per second.

“n”—Set video playback rate to 6 frames per second.

“m”—Set video playback rate to 7 frames per second.

In the above case, when the user has selected to control the speed of playback by letters, then the number keys control the selection of audible audio tracks.
“1”—Only track 1 is audible.
“2”—Only track 2 is audible.
“3”—Only track 3 is audible. etc.
   Conversely, the user can select to control the playback speed by numbers, and the letter keys can be used to control which audio is made audible.

Additional video playback rates are also selectable by using additional keyboard commands which are not listed here. If the video is currently playing when a change is made to the video playback rate, then such a change takes effect immediately and is immediately visible in the playback window, otherwise the video playback rate is stored for later use once the video playback begins.

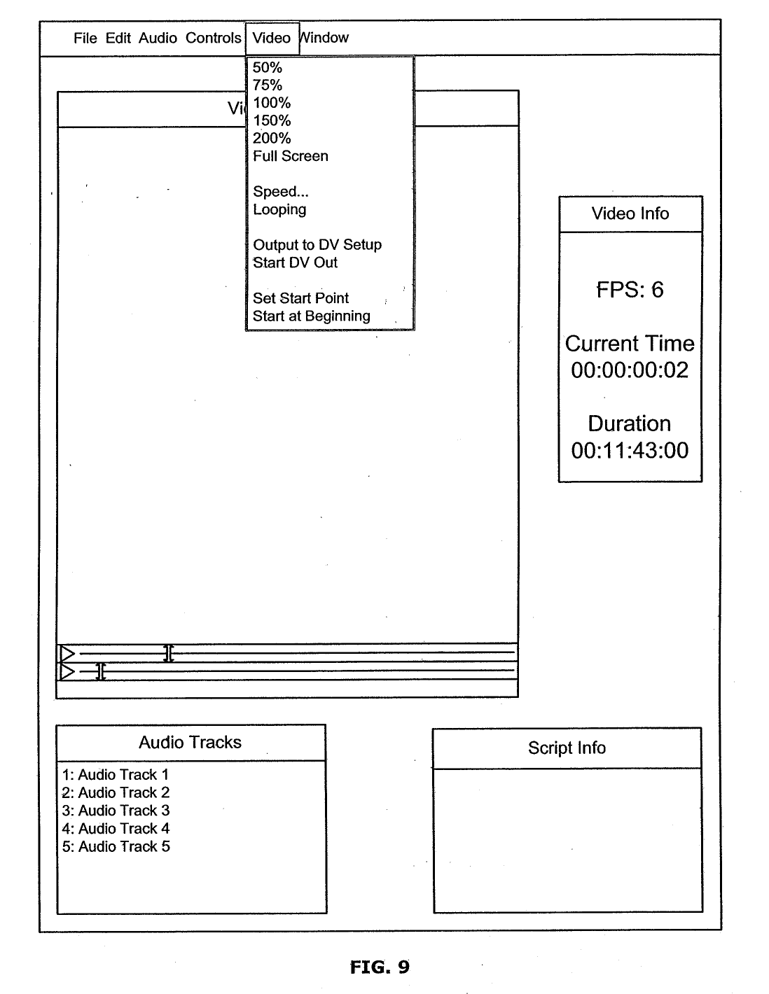

In FIG. 9, from the “Video” menu, the user may select magnifier ratios for the screen size from a drop-down list, as well as other video track control options.

In the figures, the primary two control components are displayed below the video playback display area, referred to as the “Video Window.” On the bottom right side is the “Script Info” window which displays the speed that the script is being played back at. The user can speed this up or slow it down by using arrow buttons at the bottom of the window to raise or lower the script playback speed. On the top right side is the “Video Info” window which displays the current (user controlled) frame per second playback rate, the location of the playback head in standard video time code, and the absolute length of the movie clip, if played back at normal video playback rate of 30 fps. On the bottom left side is the Audio Tracks selection box, from which the current audio track can be selected using number keyboard commands corresponding to the titles in the selection box. For example:

“1”—Select audio track 1 as the audible audio track.

“2”—Select audio track 2 as the audible audio track.

“3”—Select audio track 3 as the audible audio track.

“4”—Select audio track 4 as the audible audio track.

“5”—Select audio track 5 as the audible audio track.

Alternatively, audio tracks may be selected by clicking radio buttons next to or clicking on the linked titles appearing in the Audio Tracks selection box. Selection of a new audio track takes effect immediately. A short fade in/out period may be provided as the previous audio track is silenced and the newly selected audio track becomes audible. The new track selection is stored for later use in editing or playback.

Referring again to FIG. 2B, the typical operation of the system can be understood through an example illustrated in the state diagram (see Minimal State Diagram).

INIT State: The application software begins in the INIT state. Various variables are initialized at this point, including the Video_Playback_Rate variable, which is set to its default initial value, the Current_Audio_Track variable, which is set to one, the Video_Frame_Index variable, which is set to zero, and the Audio_Time_Index variable, which is set to zero. At this point, the initial display is presented to the user on the display device. The initial display consists of a menu, audio track selection window, video info window, and script info window. Once the system is initialized, the state transitions to the UNLOADED state.

UNLOADED State: From the UNLOADED state, the user can choose to load a video track or set the video playback rate. If the user chooses to set the video playback rate, the Set_Video_Playback_Rate function is invoked. If the user chooses to load a video track, the Load_Video_Track function is executed and the state transitions to the AUDIO PAUSED-VIDEO PAUSED state.

AUDIO PAUSED-VIDEO PAUSED State: In this state, the user may choose to load an audio track, set the video playback rate, change the currently selected audio track, set the video frame index, set the audio time index, play the audio, play the video, or play both the audio and video. If the user chooses to load an audio track, the Load_Audio_Track function is invoked. If the user chooses to set the video playback rate, the Set_Video_Playback_Rate function is invoked. If the user changes the currently selected audio track, the Select_Current_Audio_Track function is invoked. If the user changes the video frame index, the Set_Video_Frame_Index function is invoked. If the user changes the audio time index, the Set_Audio_Time_Index function is invoked. If the user chooses to play both the audio and video, the state transitions to the AUDIO PLAYING—VIDEO PLAYING state. If the user chooses to play only the audio, the state transitions to the AUDIO PLAYING-VIDEO PAUSED state. If the user chooses to play only the video, the state transitions to the AUDIO PAUSED-VIDEO PLAYING state.

AUDIO PLAYING-VIDEO PLAYING State: In this state, the user may choose to load an audio track, set the video playback rate, select the current audio track, set the video frame index, set the audio time index, pause both the audio and video, pause only the audio, or pause only the video. If the user chooses to load an audio track, the Load_Audio_Track function is invoked. If the user chooses to set the video playback rate, the Set_Video_Playback_Rate function is invoked. If the user changes the currently selected audio track, the Select_Current_Audio_Track function is invoked. If the user changes the video frame index, the Set_Video_Frame_Index function is invoked. If the user changes the audio time index, the Set_Audio_Time_Index function is invoked. If the user chooses to pause both the audio and video, the state transitions to the AUDIO PAUSED—VIDEO PAUSED state. If the user chooses to pause only the audio, the state transitions to the AUDIO PAUSED-VIDEO PLAYING state. If the user chooses to pause only the video, the state transitions to the AUDIO PLAYING-VIDEO PAUSED state. If the last frame of video is played, the state transitions to the AUDIO—PLAYING-VIDEO PAUSED state. If the last frame of audio is played, the state transitions to the AUDIO PAUSED-VIDEO PLAYING state. If both the last frame of video and the last frame of audio are played at the same time, the state transitions to the AUDIO PAUSED-VIDEO PAUSED state.

AUDIO PAUSED-VIDEO PLAYING State: In this state, the user may choose to load an audio track, set the video playback rate, select the current audio track, set the video frame index, set the audio time index, play the audio, or pause the video. If the user chooses to load an audio track, the Load_Audio_Track function is invoked. If the user chooses to set the video playback rate, the Set_Video_Playback_Rate function is invoked. If the user changes the currently selected audio track, the Select_Current_Audio_Track function is invoked. If the user changes the video frame index, the Set_Video_Frame_Index function is invoked. If the user changes the audio time index, the Set_Audio_Time_Index function is invoked. If the user chooses to play the audio, the state transitions to the AUDIO PLAYING-VIDEO PLAYING state. If the user chooses to pause the video, the state transitions to the AUDIO PAUSED-VIDEO PAUSED state. If the last frame of video is played, the state transitions to the AUDIO-PAUSED-VIDEO PAUSED state.

AUDIO PLAYING-VIDEO PAUSED State: In this state, the user may choose to load an audio track, set the video playback rate, select the current audio track, set the video frame index, set the audio time index, pause the audio, or play the video. If the user chooses to load an audio track, the Load_Audio_Track function is invoked. If the user chooses to set the video playback rate, the Set_Video_Playback_Rate function is invoked. If the user changes the currently selected audio track, the Select_Current_Audio_Track function is invoked. If the user changes the video frame index, the Set_Video_Frame_Index function is invoked. If the user changes the audio time index, the Set_Audio_Time_Index function is invoked. If the user chooses to pause the audio, the state transitions to the AUDIO PAUSED-VIDEO PAUSED state. If the user chooses to play the video, the state transitions to the AUDIO PLAYING-VIDEO PLAYING state. If the last frame of audio is played, the state transitions to the AUDIO-PAUSED-VIDEO PAUSED state.

In the described preferred embodiment, software objects, functions, methods, and APIs are used to implement the various actions which can be performed. The objects, functions, methods, and APIs are invoked in response to user input as described in the state diagram and user interface description.

Video Playback: Video playback is handled by a RealBasic MoviePlayer object. The Video_Playback_Loop function executes continuously whenever the system is in the AUDIO PAUSED-VIDEO PLAYING state or the AUDIO PLAYING-VIDEO PLAYING state. It is responsible for causing video frames to be sequentially displayed. The amount of time for which each frame is displayed is dependent on the Video_Playback_Rate variable, which is stored in units of frames per second. The frame display interval is therefore calculated as (1/Video_Playback_Rate). After each frame is displayed for the given time interval, the SetMovieTimeValue QuickTime API is used to update the movie playback position to display the next frame in the video movie.

Audio Playback: Although there is a video playback loop function, there is no corresponding audio playback loop function, as audio playback is handled automatically by the QuickTime system.

Load_Video_Track Function: This function presents the user with a list of video files contained on local and/or remote storage device(s) and allows the user to select a single video file from the list. The RealBasic GetOpenFolderltem method is used to present the dialog box to the user and obtain the folder selection from the user. This method returns a user selectable folder item which is passed to the RealBasic OpenAsMovie method to obtain a QuickTime movie object. The QuickTime movie object contains a QuickTime movie handle. This movie handle is used as to store the video track. A handle to a second QuickTime movie is then created using the NewMovie QuickTime API. This movie handle is used to store the audio tracks. If there are one or more audio tracks contained in the previously selected video file, they are each copied from the original video movie handle and attached to the newly created audio movie handle using the InsertMovieSegment QuickTime API. Once each audio track is copied, it is removed from the video movie handle using the DisposeMoveTrack QuickTime API. After each audio track is attached to the audio movie, it is marked as inaudible using the SetTrackEnabled QuickTime API. The currently selected audio track, as stored in the Current_Audio_Track variable is marked as audible using the SetTrackEnabled QuickTime API.

Load_Audio_Track Function: This function presents the user with a list of audio files contained on local and/or remote storage device(s) and allows the user to select a single audio file from the list. The RealBasic GetOpenFolderItem method is used to present the dialog box and obtain the folder selection from the user. This method returns a user selectable folder item which is passed to the RealBasic OpenAsMovie method to obtain a QuickTime movie object which contains a QuickTime movie handle. If there are one or more audio tracks contained in the selected audio file, they are each copied from the newly opened movie handle and attached to the existing audio movie handle using the InsertMovieSegment QuickTime API. After each audio track is attached to the audio movie, it is marked as inaudible using the SetTrackEnabled QuickTime API. The currently selected audio track, as stored in the Current_Audio_Track variable is marked as audible using the SetTrackEnabled QuickTime API.

Set_Video_Playback_Rate Function: This function is used to adjust the frame rate at which the video file is played back. The video file is composed of a sequence of pictures or video frames which are individually and sequentially displayed to the user within the video playback window. Each frame is displayed for a period of time which is controlled by the current setting of Video_Playback_Rate variable. The Set_Video_Playback_Rate function is used to set the Video_Playback_Rate variable.

Select_Current_Audio_Track Function: This function is used to select the currently audible audio track. Only one audio track can be audible at a given time, although a given audio track may contain multiple audio streams which are audible at the same time (for example, containing stereo or multi-track sound). The Select_Current_Audio_Track Function sets the Current_Audio_Track variable. All of the audio tracks in the audio movie are then changed to be inaudible using the SetTrackEnabled QuickTime API. The audio track which is indicated by the Current_Audio_Track variable (and only that audio track) is then set to be audible using the SetTrackEnabled QuickTime API.

Set_Current_Video_Frame_Index Function: This function is used to set the Video_Frame_Index, thus specifying the frame of video which is to be displayed. The SetMovieTimeValue QuickTime API is used to update the movie playback position to the appropriate video frame.

Set_Current_Audio_Time_Index Function: This function is used to set the current position of the audio playback within the audio movie. The SetMovieTimeValue QuickTime API is used to update the movie playback position to the appropriate audio frame.

### Scripting for Editing And Playback

The editor/player application is able to record the user's actions and generate a script. The user initiates the recording using either a particular keyboard or mouse command. Once the recording is initiated, various events from that point forward are recorded, until such time as the user terminates the recording. Events which are recorded include such actions such as the user choosing to play the audio, pause the audio, play the video, pause the video, set the video playback rate, change the current audio track, set the video frame index, and set the audio time index.

When the user initiates the recording, the current time measured in clock ticks is stored in the Recording_Time variable. When each recordable event occurs, a Delta_Time is computed by subtracting the Recording_Time from the current time. Each recorded event is then stored in an array entry, along with any associated arguments which control the behavior of that event, as well as the event's computed Delta_Time.

When the user indicates that the recording is complete, the recording can be saved as a text-based script file. One line of text is output for each entry in the event array. Each line that is output contains the event type, one or more event arguments, and the event's associated Delta_Time.

Saved scripts can be replayed at a later time. When a script is loaded, it is stored in memory in the Playback array. Each line of text from the script is stored as a unique entry in the Playback array. The Playback_Index variable is used to track the next entry in the playback array, and it is initially set to zero. When the script is loaded, the current time measured in clock ticks is stored in the Playback_Time variable.

A timer is dispatched sixty times per second which causes the Playback_Timer function to execute. The Playback_Timer function parses the entry in the Playback array at the index of Playback_Index and retrieves the associated Delta_Time. It then compares the current time to the sum of the Playback_Time and the entry's Delta_Time. If the current time is greater than or equal to the sum, then the associated event is executed by calling the associated event function with the stored event parameters, and the Playback_Index is incremented. Playback continues until the last event in the Playback_Array is executed, at which point playback stops.

For producing a program for playback and/or subsequent editing, the control instructions for controlling the underlying video and audio resources are recorded as a control file that can be retrieved for playback or modification. The program can be distributed on a CD or DVD disc recorded with the editing/playback application and the underlying video and audio tracks. The disc can thus be distributed as a PC-operable program that can be played back and modified as the user desires, without needing to go through a multimedia editing system. The invention is particularly suitable for making personally editable music video and/or playing video games, audience participation (karaoke) games, and the like.

As a further development, the invention can be adapted for use on a network or the Internet. For example, video tracks and audio tracks (songs) stored on remote devices may be linked by file-sharing to the control interface of a user. In this manner, users on a network can share video and audio files and collaborate on creating multimedia programs for themselves as viewer-participants.

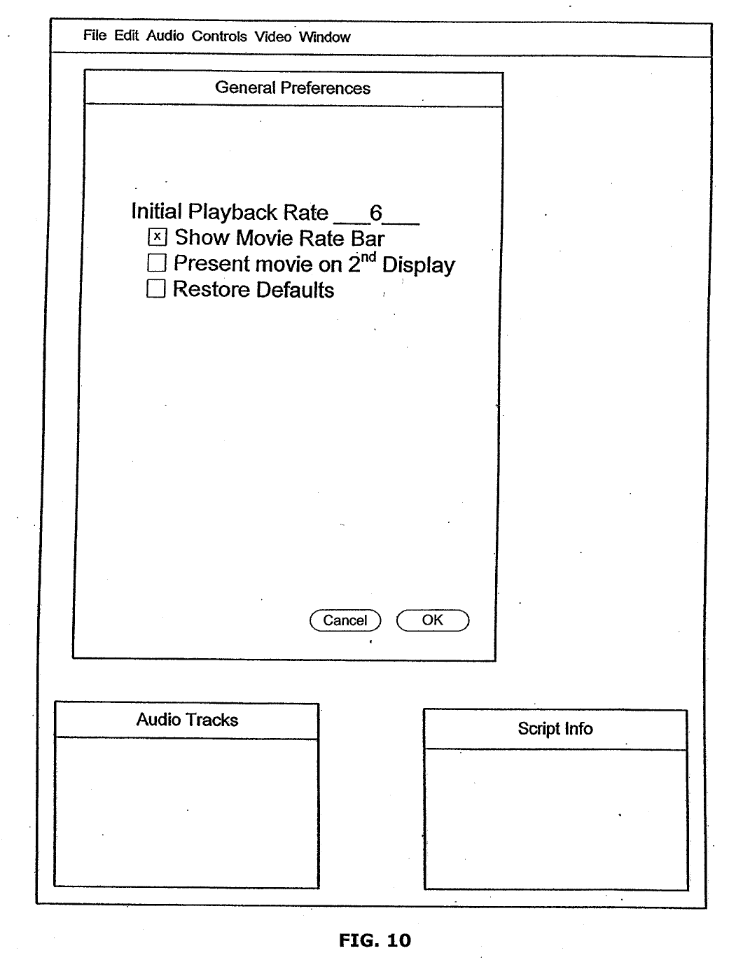

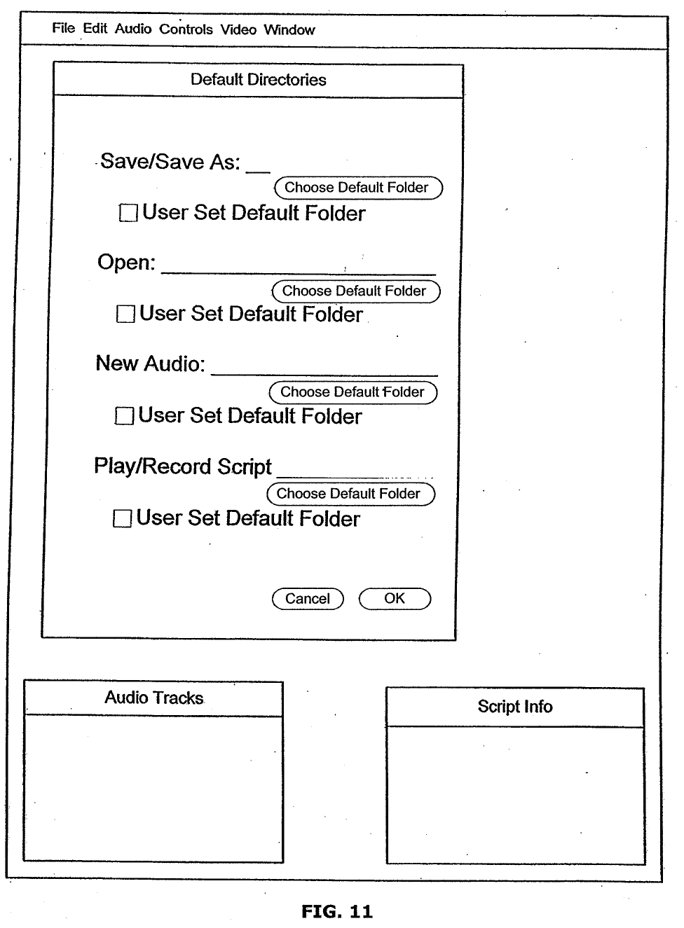

FIG. 10 illustrates a dialog box for setting general preferences for the audio-video program. The “General Preferences” dialog box allows the user to set the default playback rate in frames per second, to enable or disable the display of the movie rate bar, to select a secondary display device as the output window for the movie, and to restore the default preferences values. FIG. 11 illustrates a dialog box for setting Default Directories for the audio-video program. The “Default Directories” dialog box allows the user to set various default directories for loading and storing files.

### Internet-Enabled Embodiment

The present invention can also be adapted in an Internet-enabled embodiment for use in creating, editing, modifying, or playback of an audio-video presentation by using streaming audio and/or video from a link to one or more websites, and by storing the website link(s) with the recorded script for later playback or modification. The goal of the Internet-enabled embodiment is the same, i.e., a software-based video and audio editing and playback system having a control interface that enables a user to control the rate of display of a series of video frames as an output video track in conjunction with any one of several cued audio tracks selected on the control interface. The audio tracks can be buffered and cued to the same starting point as the start point of the video track and are running as the video track runs. The user can hop from one running audio track to another to play different songs, cadences, or audio themes that go along with the topics or themes run in the video frames of the video track.

In the Internet-enabled embodiment, the system consists of five major components: a media buffering component, a video playback component, an audio playback component, a recording component, and a user interface component. These are described in the sections below.

Media Buffering Component: The media buffering component is responsible for obtaining video data from the network and storing it in local memory prior to playback. It is designed to “absorb” the characteristics of the network (jitter, latency, etc.) and present a continuous stream of bytes to the audio and video playback components, thus presenting the playback components with something that has the key characteristics of a local file. There are two models for obtaining media data across the network: the “push” model and the “pull” model, and both are supported by the media buffering component. In the pull model, the client must specifically request each chunk of data that it wants from the server. This model matches the way in which files are read locally and it is the typical model for retrieving files from a remote file server, however it is generally not optimal for streaming media. In the push model, the server is responsible for continuously sending the data to the client without the need for repeated requests from the client. This is the model that is typically used for a streaming media service.

The media buffering component manages a set of media buffers—one per media stream. In this embodiment, the buffers are implemented as circular buffers, although other mechanisms could be used instead, such as a linked list. In the circular buffer implementation, pointers are kept to indicate the start of the buffer, the end of the buffer, the head of the buffer, and the tail of the buffer. The head of the buffer is the place at which new data is added, and the tail of the buffer is the place at which data is removed from the buffer. The start of the buffer marks the point at which the buffer starts in memory and the end of the buffer marks the point at which the buffer ends in memory. Even though the start of the buffer is physically separated from the end of the buffer, since the circular buffer is simulating a looping structure, the start of the buffer logically begins immediately after the end of the buffer, and therefore the “wrap point” is demarcated by the end of the buffer. The current fullness of the buffer can be calculated by measuring the distance between the head and the tail pointers, being careful to adjust appropriately in cases where the head and tail are on opposite sides of the wrap point and therefore the logical distance is different from the physical distance. In addition, a “high water mark,” and a “low water mark” are calculated for each buffer. The high water mark and low water mark are chosen based on the characteristics of the particular media stream being kept in the given buffer (e.g. bit rate) along with the characteristics of the network through which they are being transmitted (e.g. jitter, latency, and bandwidth).

In the push model, if the buffer is or becomes less full than the low water mark, the media buffering component will send a “start” command to the server, indicating that the server should begin sending more media data on that particular stream. When the buffer becomes fuller than the high water mark, the media buffering component will send a “pause” command to the server, indicating that the server should stop sending media data until more is requested.

In the pull model, individual read requests are sent to the server for each chunk of data that is required. Since such requests contain an offset and a data length, no explicit “start” and “pause” commands are required. The media buffering component simply requests the exact amount of data which it calculates that it needs to reach the high water mark.

Video Playback Component: The video playback component is responsible for displaying frames of video to the display device and responding to requests from the user interface component to change the video display frame rate.

Audio Playback Component: Depending on the available network bandwidth and other considerations, it may be desirable to connect to, and receive data from, multiple audio tracks at once, in order to facilitate quickly switching between multiple audio tracks. Since only one audio track is played back to the user at a time, the data from the remaining tracks must be discarded. The audio playback component is responsible for obtaining audio frames from the media buffering component and either: (a) presenting the frames to the audio playback device (if they are frames from the currently selected audio track); or (b) discarding the frames.

In the case where the client is connected to, and receiving data from, multiple audio tracks at once, the audio playback component is also responsible for setting which track is marked as the currently selected audio track, at the request of the user interface component.

In some cases, depending on the available network bandwidth and other considerations, it may be desirable to only stream one audio track at a time from the server to the client. In such a scenario, the user is still able to switch between multiple audio tracks and the server (instead of the client) is responsible for actually switching between these various audio tracks at the request of the client. In such a scenario, the Audio Playback Component is responsible for indicating to the server when it should switch to a different track and to which track it should switch, at the request of the user interface component.

Recording Component: The recording component is responsible for capturing the identity of the media streams which are being played back, the user interactions that are performed, and the time relationships between a given user interaction and the audio and video stream that is played in response to said user interaction. By recording these events and time relationships, it is possible to play back a user-created presentation at a later time.

The following events are recorded by the Recording Component:

Connect_Video_Track—for each video track that is selected by the user, an event is recorded which includes the following properties: current system time, and network location of the selected video track.

Connect Audio Track—for each audio track that is selected by the user, an event is recorded which includes the following properties: current system time, and network location of the selected audio track.

Set_Video_Playback_Rate—each time the user modifies the video playback rate, an event is recorded which includes the following properties: current system time, and new playback rate.

Select_Current_Audio_Track—each time the user changes the currently selected audio track, an event is recorded which includes the following properties: current system time, audio track identifier, and presentation time stamp of the first frame of audio which will be played from the newly selected audio track.

The current system time that is recorded in the Select_Current_Audio_Track event is the system time at the moment that the newly selected audio track actually begins playing.

In some cases, depending on the available network bandwidth and other considerations, it may be desirable to only stream one audio track at a time from the server to the client. In such a scenario, the server (instead of the client) is responsible for switching between the various audio tracks in such a way that the client continues to receive a single continuous audio stream during the transition between audio tracks. Additionally, the server inserts a marker frame into the audio stream at the actual point of transition which indicates to the client the exact point at which the stream is being switched. The marker frame is a specially crafted audio packet which can be detected by the client but does not affect the audio output. The client can calculate the time that the newly selected audio track actually begins playing by observing the marker frame. As noted above, this time is then stored in the recorded event.

In one embodiment, the audio streams are transmitted using MPEG layer 3 encoded audio frames. Per the MPEG layer 3 specification, each frame contains a frame header wherein one bit is identified as the Private bit. In this particular embodiment, during normal operation the server sets the Private bit on each frame to 0 prior to sending it to the client. During the transition between one selected audio track and another, the server sets the Private bit within the first frame of the newly selected audio track to 1. In this way, the client can detect the moment of transition from one audio track to another.

Video Playback Start—each time video playback begins, an event is recorded which includes the following properties: current system time, and presentation time stamp of the first frame of video which will be displayed.

Video Paused—each time video playback stops, an event is recorded which includes the following properties: current system time.

Audio Playback Start—each time audio playback begins, an event is recorded which includes the following properties: current system time, and presentation time stamp of the first frame of audio which will be played.

Audio Paused—each time audio playback stops, an event is recorded which includes the following properties: current system time.

User Interface Component: The user interface component is responsible for capturing input from the user and controlling the behavior of the various other components. It is responsible for instructing the media buffering component to connect to one or more media streams, instructing the audio and/or video playback components to begin playing and to pause, instructing the video playback component to change the current frame rate, and instructing the audio playback component to change the current audio stream.

The operation of the Internet-enabled system may be understood through the use of a state diagram. FIG. 12 illustrates a state diagram of control instructions for the Internet-enabled embodiment in an example of adjusting the video speed to synchronize with different audio tracks. The blocks of the state diagram are described in the sections below.

INIT State: The application software begins in the INIT state. Various variables are initialized at this point, including the Video_Playback_Rate variable, which is set to it's default initial value, and the Current_Audio_Track variable, which is set to one. Once the system is initialized, the state transitions to the VIDEO SELECTION state.

VIDEO SELECTION State: From the VIDEO SELECTION state, the user can select a server and video track. In the initial implementation, this is simply a text display which requests that the user enter a server and file in standard URL notation. This is only an example as various graphical methods could be used instead. Once the user selects a server and video track, the Connect_Video_Track function is executed and the state transitions to the AUDIO SELECTION state.

AUDIO SELECTION State: From the AUDIO SELECTION state, the user can select an additional server and audio track, or choose to stop adding audio tracks. If the user selects a server and audio track, the Connect_Audio_Track function is executed and the state stays in the AUDIO SELECTION state. In the initial implementation, this is simply a text display which requests that the user enter a server and file in standard URL notation. This is only an example as various graphical methods could be used instead. If the user chooses to stop adding audio tracks, the state transitions to the FILL BUFFERS state.

FILL BUFFERS State: During the VIDEO SELECTION state and the AUDIO SELECTION state, the media buffering component was instructed to begin filling the media buffers for each connected media stream. During the FILL BUFFERS state, the system waits for all of these buffers to fill. When each of these buffers has filled at least to the point of its respective high water mark, the state then transitions to the AUDIO PAUSED-VIDEO PAUSED state.

AUDIO PAUSED-VIDEO PAUSED State: From the AUDIO PAUSED-VIDEO PAUSED state, the user may choose to set the video playback rate, change the currently selected audio track, play the audio, play the video, or play both the audio and video. If the user chooses to set the video playback rate, the Set_Video_Playback_Rate function is invoked. If the user changes the currently selected audio track, the Select_Current_Audio_Track function is invoked. If the user chooses to play both the audio and video, the state transitions to the AUDIO PLAYING-VIDEO PLAYING state. If the user chooses to play only the audio, the state transitions to the AUDIO PLAYING-VIDEO PAUSED state. If the user chooses to play only the video, the state transitions to the AUDIO PAUSED-VIDEO PLAYING state.

AUDIO PLAYING-VIDEO PLAYING State: From the AUDIO PLAYING-VIDEO PLAYING state, the user may choose to set the video playback rate, select the current audio track, pause both the audio and video, pause only the audio, or pause only the video. If the user chooses to set the video playback rate, the Set_Video_Playback_Rate function is invoked. If the user changes the currently selected audio track, the Select_Current_Audio_Track function is invoked. If the user chooses to pause both the audio and video, the state transitions to the AUDIO PAUSED—VIDEO PAUSED state. If the user chooses to pause only the audio, the state transitions to the AUDIO PAUSED-VIDEO PLAYING state. If the user chooses to pause only the video, the state transitions to the AUDIO PLAYING-VIDEO PAUSED state. If the last frame of video is played, the state transitions to the AUDIO—PLAYING-VIDEO PAUSED state. If the last frame of audio is played, the state transitions to the AUDIO PAUSED-VIDEO PLAYING state. If both the last frame of video and the last frame of audio are played at the same time, the state transitions to the AUDIO PAUSED-VIDEO PAUSED state.

AUDIO PAUSED-VIDEO PLAYING State: From the AUDIO PAUSED-VIDEO PLAYING state, the user may choose to set the video playback rate, select the current audio track, play the audio, or pause the video. If the user chooses to set the video playback rate, the Set_Video_Playback_Rate function is invoked. If the user changes the currently selected audio track, the Select_Current_Audio_Track function is invoked. If the user chooses to play the audio, the state transitions to the AUDIO PLAYING-VIDEO PLAYING state. If the user chooses to pause the video, the state transitions to the AUDIO PAUSED-VIDEO PAUSED state. If the last frame of video is played, the state transitions to the AUDIO-PAUSED-VIDEO PAUSED state.

AUDIO PLAYING-VIDEO PAUSED State: From the AUDIO PLAYING-VIDEO PAUSED state, the user may choose to set the video playback rate, select the current audio track, pause the audio, or play the video. If the user chooses to set the video playback rate, the Set_Video_Playback_Rate function is invoked. If the user changes the currently selected audio track, the Select_Current_Audio_Track function is invoked. If the user chooses to pause the audio, the state transitions to the AUDIO PAUSED-VIDEO PAUSED state. If the user chooses to play the video, the state transitions to the AUDIO PLAYING-VIDEO PLAYING state. If the last frame of audio is played, the state transitions to the AUDIO-PAUSED-VIDEO PAUSED state.

In the Internet-enabled embodiment, software objects, functions, methods, and APIs are used to implement the various actions which can be performed. The objects, functions, methods, and APIs are invoked in response to user input as described in the state diagram and user interface description.

Video Playback: The Video_Playback_Loop function executes continuously whenever the system is in the AUDIO PAUSED-VIDEO PLAYING state or the AUDIO PLAYING-VIDEO PLAYING state. It is responsible for causing video frames to be sequentially displayed. The amount of time for which each frame is displayed is dependent on the Video_Playback_Rate variable, which is stored in units of frames per second. The frame display interval is therefore calculated as (1/Video_Playback_Rate).

Audio Playback: The Audio_Playback_Loop function executes continuously whenever the system is in the AUDIO PLAYING-VIDEO PAUSED state or the AUDIO PLAYING-VIDEO PLAYING state. It is responsible for causing audio frames to be sequentially output to the audio hardware.

Connect_Video_Track Function: The Connect_Video_Track function instructs the media buffering component to connect to and begin streaming video from the given server and media stream. Media streams are supplied to the function in standard URL notation.

Connect_Audio_Track Function: The Connect_Audio_Track function instructs the media buffering component to connect to and begin streaming audio from the given server and media stream. Media streams are supplied to the function in standard URL notation.

Set_Video_Playback_Rate Function: The Set_Video_Playback_Rate function is used to adjust the frame rate at which the video file is played back. The video file is composed of a sequence of pictures or video frames which are individually and sequentially displayed to the user within the video playback window. Each frame is displayed for a period of time which is controlled by the current setting of Video_Playback_Rate variable. The Set_Video_Playback_Rate function is used to set the Video_Playback_Rate variable.

Select_Current_Audio_Track Function: The Select_Current_Audio_Track function is used to select the currently audible audio track. Only one audio track can be audible at a given time, although a given audio track may contain multiple audio streams which are audible at the same time (for example, containing stereo or multi-track sound). The Select_Current_Audio_Track Function sets the Current_Audio_Track variable.

User Interface Flow: The user interface component is responsible for interacting with the remaining components and controlling the overall functioning of the system. Once it reaches the VIDEO SELECTION state, the user interface allows the user to select a video stream. In the initial implementation, this is simply a text display which requests that the user enter a server and file in standard URL notation. This is only an example as various graphical methods could be used instead. Similarly, in the AUDIO SELECTION state, the user interface allows the user to select one more audio streams. Again, in the initial implementation, this is simply a text display which requests that the user enter a server and file in standard URL notation. This is only an example as various graphical methods could be used instead. After each stream selection is complete, the user interface component instructs the media buffering component to connect to each media stream and beginning collecting data. Once the user has finished selecting the streams, the system transitions to the FILL BUFFERS state and waits until each of the buffers are appropriately filled, at which point the system behaves like a simplified version of the original LandyVision invention. These simplifications are merely implementation expediencies of the current embodiment and should not limit the invention. Operations available at this point include pausing and playing the video, pausing and playing the audio, switching among the previously selected audio tracks, and changing the video frame rate.

The Internet-enabled embodiment allows the system to interact with streaming media, including audio and video content sent across various types of networks. Such networks may have different combinations of bandwidth and latency characteristics. The system can be adapted to a typical handheld media device, such as an Apple iPhone™ or iPod™ device, that is Internet-connected on a typical 3G mobile broadband network.

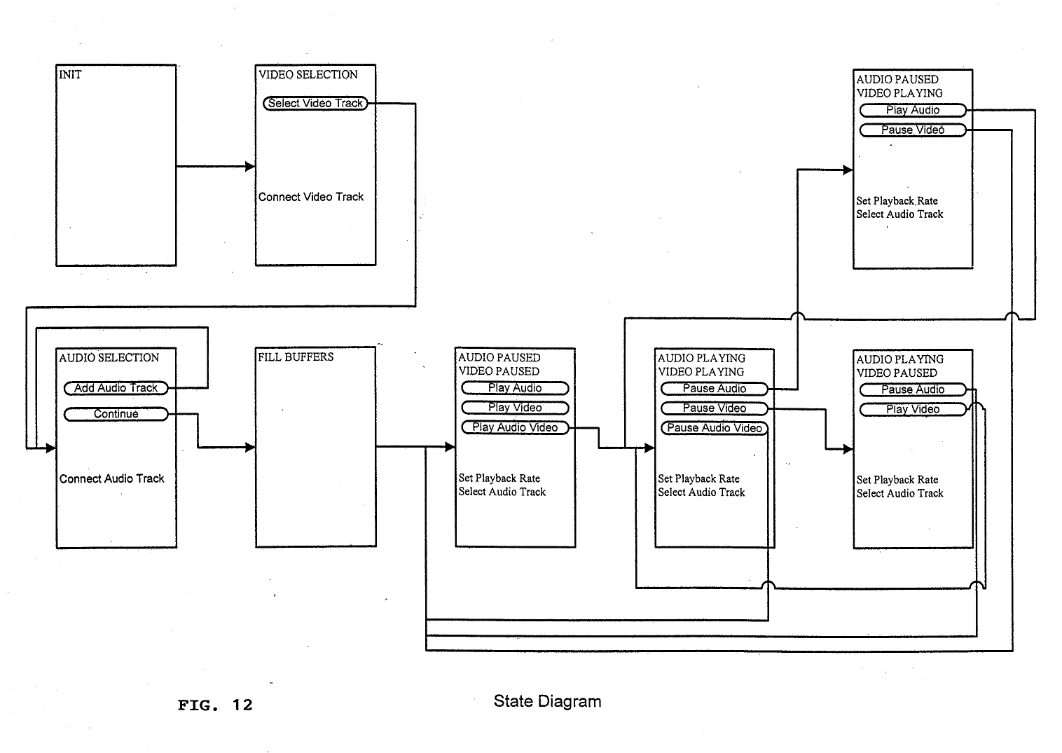

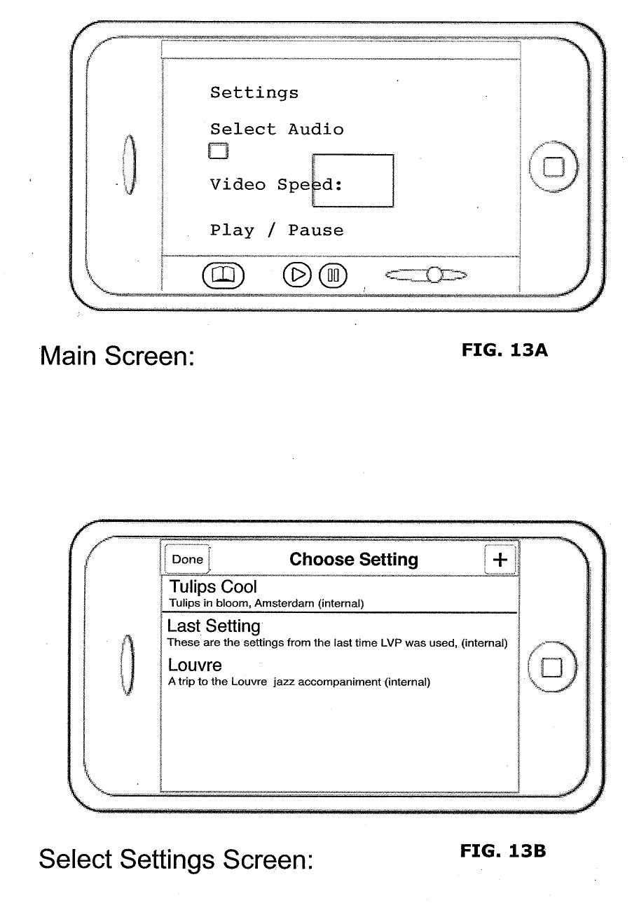

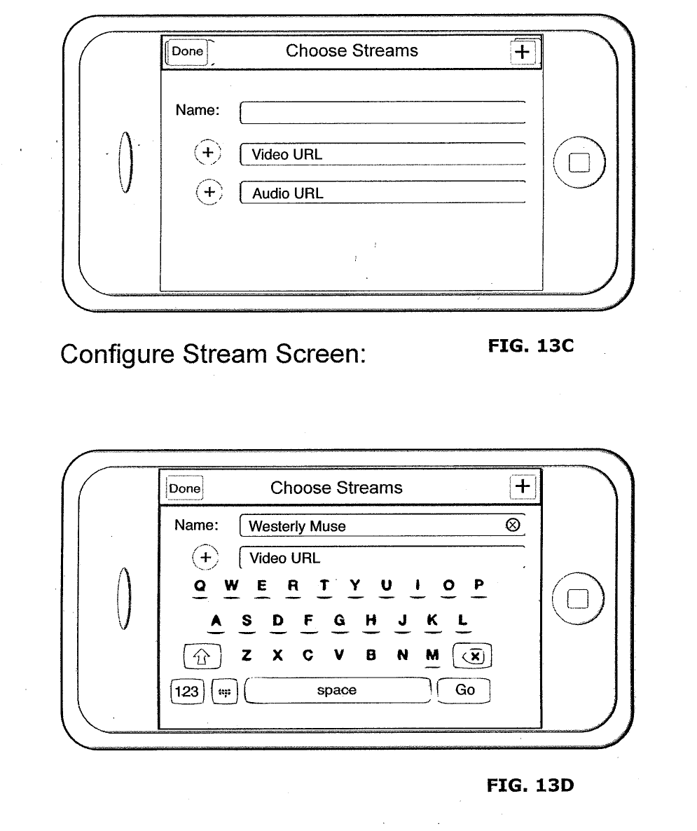

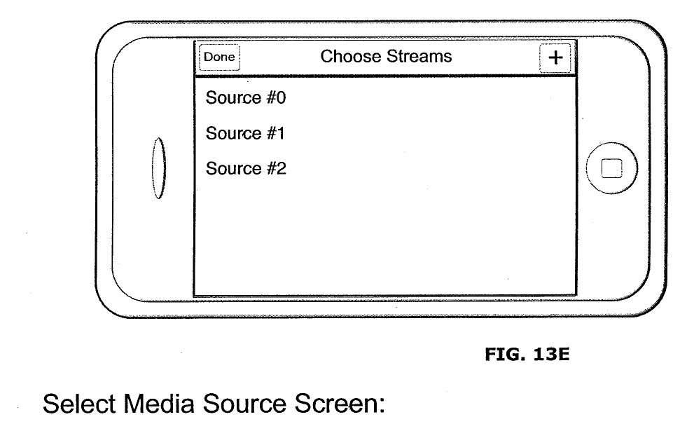

FIGS. 13A-13E illustrate user interface displays for the functions of the system adapted to a mobile Internet-connected handheld device such as an Apple iPhone™ or iPod™ device. A stream server controlled with standard RTSP over HTTP commands can provide streaming video content and audio content, which can be interactively chosen upon linking to the website sources. Furthermore, media locally stored and available on the device can also be chosen as the media resources to be used. The server's streamed video resolution will be tailored to the player's video resolution. The server will provide streamed video frames which will be buffered by the client system. The client system will play these frames in a different thread at a speed set in the client user interface. The client system will be able to record changes to the playback frame rate and store these changes as part of a recorded performance.

FIG. 13A illustrates a Main Screen in which the User display interface is designed to work in Landscape mode. To maximize the video viewing area, the control toolbar hides itself after a few seconds. It is revealed again by the user touching the display area. The Screen will start with settings remembered from the last time the application was run. The Main Screens toolbar has controls to: (1) Transition to the settings screen; (2) Select audio tracks to be cued for play; (3) Play/Pause the video or audio; and (4) Choose a video play speed. The controller will change to display the current running speed. The frame rate may also be manipulated by replaying a previously recorded series of frame rate changes.

FIG. 13B illustrates a Select Settings Screen to allow setting of a video stream URL, an audio stream URL, and a starting video play speed. There may be more components to the settings that may be selected. The User interface is designed to stay in Landscape mode. A scrolling list of already configured settings is presented. Touching a setting name will stop the current stream, load that setting, and start it streaming. A “+” control is available to create new settings. Certain settings will come pre-loaded with the application, and will not be able to be removed.

FIGS. 13C and 13D illustrate a Configure Stream Screen in which an individual stream is specified in settings for all its properties, including its name and URL source for audio or video stream. Other properties may be specified, such as comments, authorship, and recorded speed of the stream. The “+” button selects a screen to pick these from. Selection of a stream brings up a display of softkeys for entry of the stream data.

FIG. 13E illustrates a Select Media Source Screen which displays the available Sources for streamed video and audio resources. When choosing a video URL from the Select Settings screen, the screen only shows video streams, and likewise, when choosing an audio streaming source, only audio sources are shown. Alternatively, the display may combine streams from many sources into sections of this screen, for instance, streams coming from one or more servers, and streams coming from the user's own music directories found on the device itself. The user chooses a media source by touching its name. The technical details about the stream may be hidden from the user to keep the screen uncluttered.

For streaming video playback, buffering enables video frames to be played at any desired rate. Since a typical server streams video at 24 or 30 fps, and the user may choose playing back between 1 to 10 fps, there will always be more data available in the buffer than needed. A determination is made when to pause the server so as not to overflow the client buffers, as described previously. For handheld device in which the dual audio and video controls are operated by the user's touch gesture inputs, the system monitors the parametric value indicated by the gesture input of the user and records the parametric value with the script for later editing or playback.

Another feature which may be included for a more convenient, easily operated user control interface for audio-video synchronization is an automatic beat recognition which, at the user's option, will automatically control the speed of the video play. This software-based feature is designed to automatically detect the beat and/or other audio properties of the currently selected audio track and convert the beat frequency into a playspeed (frames per second) for the video. The user can use this Auto Beat play speed as the current video play speed or adjust it either forward or in reverse. The play speed value will be constantly monitored as the audio tracks are played and the user will be able to toggle it on and off using a dedicated control (button, menu item, mouse location on screen, keyboard control, etc.) so that it converts the play speed of the video track from previously selected video play speed. The user will be able to toggle back and forth between manually selected play speeds and Auto Beat play speeds.

The Auto Beat function can further have user-adjustable parameters to adjust the influence of the various properties of the music on the calculated play speed. Such audio properties include, but are not limited to, amplitude, frequency, pitch, and gating, which may qualitatively influence the video play speed that would appear to better match the music in synchronization. The Auto Beat function can calculate several options for the Auto Beater play speed, and the user can choose which option appears better synchronized to the music.

### SUMMARY

The application described is novel in both its purpose and its implementation. A dual-control interface is used to adjust speed of an underlying video resource in real time independently of the audio, while simultaneously the user can select any audio in real time from among multiple audio tracks. The user is provided with the ability to create a unique audio-visual experience which can not be created using existing methods. Pre-recorded video speed and audio selection commands can be distributed on a disc with the audio-video system application and underlying video and audio tracks for play on PCs or game consoles, as well as mobile devices, Internet browsers, etc. The user can compose and play the audio-video resources extemporaneously, or edit a work, re-edit or playback a pre-recorded work, without needing to make modifications through an editing system. AUDIO/VIDEO programs can be made self-contained and played or operated in any desired mode on any type of compatible device, as well as broadcast, cablecast, podcast programs, etc.

It is understood that many modifications and variations may be devised given the above description of the principles of the invention. It is intended that all such modifications and variations be considered as within the spirit and scope of this invention, as defined in the following claims.

1. An audio-video system operable on a computer device comprising:
(a) a video controller for running an underlying video resource composed as a series of digital image frames of visual content for video output;
(b) an audio controller for running a plurality of underlying audio resources and selectively switching among them for audio output, wherein any one of the underlying audio resources can be selectively switched by the audio controller for audio output; and
(c) a dual-control interface operable by a user of the system for controlling the underlying video resource and plurality of audio resources, wherein said dual-control interface includes a video speed control for providing a video speed command to the video controller for adjusting the running speed of digital image frames of visual content from the video resource at any point in time, and an audio selection control for providing an audio selection command to the audio controller for selectively switching to any one of the plurality of underlying audio resources for audio output at any point in time independently of the video speed control,
wherein the system is Internet-enabled to connect to websites on the Internet and obtain streaming audio and/or video resources from Internet websites.

2. The audio-video system according to claim 1, wherein the video speed and audio selection commands input through the control interface are recorded as an output file for later playback.

3. The audio-video system according to claim 2, wherein during playback mode, the recorded video speed and audio selection commands are played back and used to control the underlying video and audio resources in real-time.

4. The audio-video system according to claim 1, wherein the dual-control interface is operated by a user for extemporaneously composing an audio-visual program.

5. The audio-video system according to claim 1, wherein the video resource is video content that is captured or converted to a video file in digital format.

6. The audio-video system according to claim 1, wherein the audio resources are audio content that are captured or converted to audio files in digital format.

7. The audio-video system according to claim 1, wherein the video speed control of the dual-control interface adjusts the speed of the video resource to aesthetically match any one of the plurality of audio resources selected at different points in time.

8. The audio-video system according to claim 1, wherein the audio resources are an available resource selected from the group consisting of: stored audio files; live microphone input;
long-format audio or looped tracks; and streaming audio from a website.

9. The audio-video system according to claim 1, wherein the system obtains streaming audio and/or video resources from Internet websites, and records link addresses for the Internet websites with the video speed and audio selection commands input as an output file for later playback or modification

10. The audio-video system according to claim 9, wherein the audio resources are cued to start together at the same time so that the user can quickly switch from one audio track to another at different points in time of the running of the video resource.

11. The audio-video system according to claim 1, wherein the video resource is an available resource selected from the group consisting of: stored video files; still-image frames from stop-motion photography; and streaming video from a website.

12. The audio-video system according to claim 1, wherein the video speed and audio selection commands and underlying video and audio resources are recorded on disks for operation on PCs or games consoles.

13. The audio-video system according to claim 1, wherein the video speed and audio selection commands are recorded for use on Internet-connected mobile devices or Internet browsers in conjunction with streaming audio and/or video resources obtained from Internet websites.

14. The audio-video system according to claim 1, adapted for use on a network or the Internet, wherein the video and audio resources are stored on remote devices and linked by file-sharing to the control interface of a user.

15. A method of selectively operating audio and video resources in editing and playback modes on a computing device comprising:
(a) running an underlying video resource composed as a series of digital image frames of visual content for video output;
(b) running a plurality of underlying audio resources and selectively switching among them for audio output, wherein any one of the underlying audio resources can be selectively switched by the audio controller for audio output; and
(c) controlling the underlying video resource and plurality of audio resources by providing a video speed command for adjusting the running speed of digital image frames of visual content from the video resource at any point in time, and providing an audio selection command for selectively switching to any one of the plurality of underlying audio resources for audio output at any point in time independently of the video speed control,
and employing an Internet connection for connecting to websites on the Internet and obtaining streaming audio and/or video resources from Internet websites.

16. The audio-video method according to claim 15, further including recording link addresses for the Internet websites with the video speed and audio selection commands input as an output file for later playback or modification.

17. The audio-video method according to claim 16, wherein during playback mode, the recorded video speed and audio selection commands are played back and used to control the underlying video and audio resources in real-time.

18. The audio-video method according to claim 15, wherein the video speed and audio selection commands are generated by a user for extemporaneously composing an audio-visual program.

19. The audio-video method according to claim 15, wherein the video speed and audio selection commands are recorded for use on Internet-connected mobile devices or Internet browsers in conjunction with streaming audio and/or video resources obtained from Internet websites.

20. A method of selectively operating audio and video resources on a computing device in editing and playback modes comprising:
(a) running an underlying video resource composed as a series of digital image frames of visual content for video output;
(b) running a plurality of underlying audio resources and selectively switching among them for audio output, wherein any one of the underlying audio resources can be selectively switched by the audio controller for audio output; and
(c) controlling the underlying video resource and plurality of audio resources by providing a video speed command for adjusting the running speed of digital image frames of visual content from the video resource at any point in time, and providing an audio selection command for selectively switching to any one of the plurality of underlying audio resources for audio output at any point in time independently of the video speed control, and
(d) automatically detecting the beat of the currently selected audio resource with a software-based auto-beat function and converting the detected beat frequency to a running speed for the video resource.
